(19) United States
(12) Patent Application Publication
(10) Pub. No.: US 2016/0356016 A1
(43) Pub. Date: Dec. 8, 2016

(54) FRAME FOR SUPPORTING A RADIATOR GUARD OF A MACHINE

(71) Applicant: Caterpillar Inc., Peoria, IL (US)

(72) Inventor: Joshua D. Hicke, Morton, IL (US)

(73) Assignee: Caterpillar Inc., Peoria, IL (US)

(21) Appl. No.: 15/238,263

(22) Filed: Aug. 16, 2016

(51) Int. Cl. E02F 9/08; B62D 21/18; B62D 25/08; B60K 11/04

(52) U.S. Cl. CPC E02F 9/0808; B60K 11/04; B62D 21/186; B62D 25/084; E02F 9/0866; E02F 3/7604

(57) ABSTRACT

A frame for supporting a radiator guard of a machine is provided. The frame includes a first longitudinal member, a second longitudinal member, and a third member. The first longitudinal member and the second longitudinal member extend along a length of the machine. The first and second longitudinal members include a first and second pivot attachment portions, respectively, positioned proximal to a front end of the machine. The first pivot attachment portion and the second pivot attachment portion pivotally support the radiator guard, which includes a bottom portion. The third member is positioned beneath the bottom portion, defining a gap. The gap routes a plurality of flexible members in an upright position of the radiator guard. The third member includes an indented portion proximal to the bottom portion. In an inclined position of the radiator guard, the indented portion accommodates the flexible members passing through the gap.

### TECHNICAL FIELD

The present disclosure relates to a frame of a machine. More particularly, the present disclosure relates to the frame for supporting a radiator guard of the machine.

### BACKGROUND

Machines, such as track type tractors, employ a radiator for cooling an engine of the machines. Additionally, such machines employ a frame and a radiator guard, to correspondingly support and protect the radiator. The frame includes two parallel longitudinal members and a number of lateral members extending between the two parallel longitudinal members. One of the lateral members is positioned proximal to a front end of the machine. Further, the radiator guard is installed on the frame, proximal to the front end of the machine. In some machines, the radiator guard is pivotally attached to the frame. More specifically, the radiator guard is pivotally attached to the frame, such that a gap is formed between a bottom portion of the radiator guard and the lateral member of the frame.

Conventionally, a number of flexible members, such as hosepipes and electrical cables, are routed through the bottom portion of the radiator guard and then through the gap between the bottom portion and the lateral member. In some cases, the radiator may require to be serviced and/or repaired. In order to access the radiator for service and repair, the radiator guard is pivotally rotated about a lateral axis. During such pivotal movement of the radiator guard, the gap reduces and the flexible members are constrained between the bottom portion of the radiator guard and the lateral member. Repeated pivotal movement of the radiator guard may cause wear and tear of the flexible members, which may result in reduced durability of the flexible members.

U.S. Pat. No. 4,191,401 describes a nose construction for a front portion of a vehicle frame. The nose construction includes a tube and a pair of gusset structures to improve strength of the front portion of the vehicle frame. Additionally, a radiator guard mounting block is supported on the nose construction. However, the '401 reference does not disclose prevention of wear and tear of the flexible members during pivotal movement of the radiator guard. Hence, there exists a need for an improved construction of the frame of the machine.

### SUMMARY OF THE DISCLOSURE

Various aspects of the present disclosure are directed towards a frame for supporting a radiator guard of a machine. The frame includes a first longitudinal member, a second longitudinal member, and a third member. The first longitudinal member extends along a length of the machine. The first longitudinal member includes a first pivot attachment portion. The first pivot attachment portion is located proximal to a front end of the machine. The second longitudinal member extends along the length of the machine. The second longitudinal member is positioned parallel to the first longitudinal member. The second longitudinal member includes a second pivot attachment portion. The second pivot attachment portion is located proximal to the front end of the machine. The second pivot attachment portion and the first pivot attachment portion pivotally support the radiator guard, which includes a bottom portion. The third member laterally extends between the first longitudinal member and the second longitudinal member. The third member is positioned beneath the bottom portion of the radiator guard, such that a gap is defined between the bottom portion and the third member. The third member includes an indented portion, positioned proximal to the bottom portion of the radiator guard. In an upright position of the radiator guard, a number of flexible members are routed through the gap. In an inclined position of the radiator guard, the flexible members are accommodated within the indented portion of the third member.

### BRIEF DESCRIPTION OF THE DRAWINGS

FIG. 1 is a side view of an exemplary machine, in accordance with the concepts of the present disclosure;

FIG. 2. is a perspective view of a frame of the machine of FIG. 1, in accordance with the concepts of the present disclosure;

FIG. 3 is a perspective view of an assembly between the frame and a radiator guard of the machine of FIG. 1, illustrating the radiator guard positioned in an upright position, in accordance with the concepts of the present disclosure;

FIG. 4 is a perspective view of the assembly between the frame and the radiator guard of the machine of FIG. 1, illustrating the radiator guard positioned in an inclined position, in accordance with the concepts of the present disclosure;

FIG. 5 is a cut section of a portion of the arrangement between the frame and the radiator guard of FIG. 2, taken along a section A-A′, in accordance with the concepts of the present disclosure; and

FIG. 6 is a cut section of a portion of the arrangement between the frame and the radiator guard of FIG. 3, taken along a section B-B′, in accordance with the concepts of the present disclosure.

### DETAILED DESCRIPTION

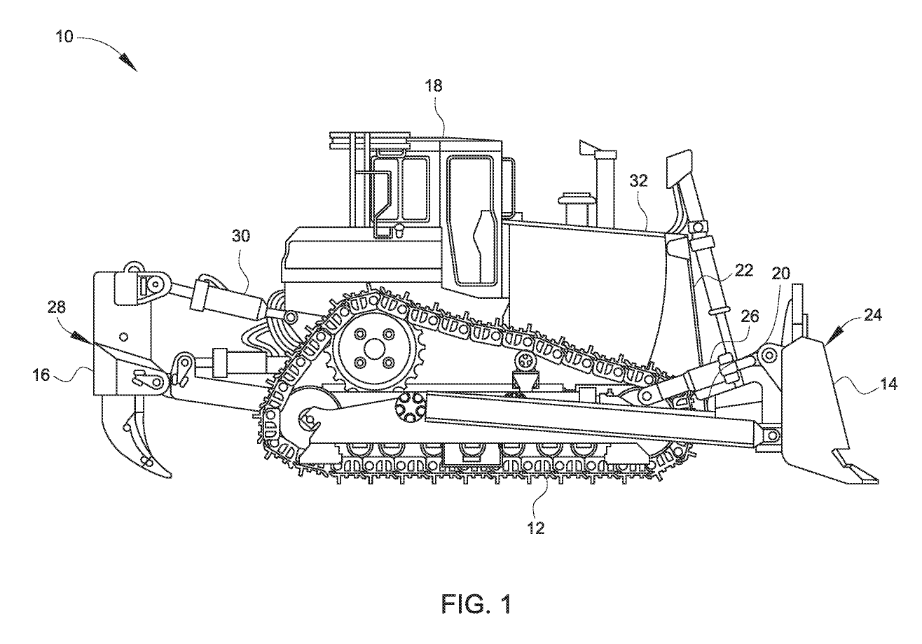

Referring to FIG. 1, there is shown an exemplary machine 10. The machine 10 is a track type tractor that performs various operations on a work surface (not shown). Although, in the present disclosure, the machine 10 is described as the track type tractor, various other types of the machine 10 may also be contemplated. Examples of the machine 10 include, but is not limited to, an excavator, a wheeled loader, and a soil compactor. The machine 10 includes a pair of tracks 12, a blade 14, a ripper 16, an operator station 18, an engine (not shown), a frame 20, and a radiator guard 22. Each of the blade 14, the ripper 16, the operator station 18, the engine (not shown), and the radiator guard 22 are supported on the frame 20, which in turn is supported on the pair of tracks 12.

The pair of tracks 12 is a conventional track assembly, each of which is positioned on either side of the machine 10. The pair of tracks 12 maneuvers the machine 10 on the work surface (not shown).

The blade 14 is positioned proximal to a front end 24 of the machine 10. The blade 14 removes debris from the work surface (not shown), as the machine 10 maneuvers forward. A number of blade hydraulic units 26 are employed to adjust an orientation of the blade 14.

The ripper 16 is positioned proximal to a rear end 28 of the machine 10. The ripper 16 performs ripping operation on the work surface (not shown), as the machine 10 maneuvers forward. A number of ripper hydraulic units 30 are employed to adjust an orientation of the ripper 16.

The operator station 18 is a cabin, where an operator may be positioned and access a number of control interfaces (not shown) of the machine 10. More specifically, an operator may be positioned within the operator station 18 and access the control interfaces not shown), to control one or more components of the machine 10. For example, the operator may access the control interfaces (not shown), to control one or more of the blade 14, the ripper 16, and the pair of tracks 12 of the machine 10.

The machine 10 employs the engine (not shown) housed within an engine compartment 32. The engine (not shown) generally employs a radiator (not shown), for cooling the engine (not shown). The radiator (not shown) is supported on the frame 20, proximal to the front end 24 of the machine 10. Additionally, the radiator guard 22 is employed to protect the radiator shown) from external environment. A structure and arrangement of the frame 20 and the radiator guard 22 to support and protect the radiator (not shown), respectively, will be described in details in the forthcoming disclosure.

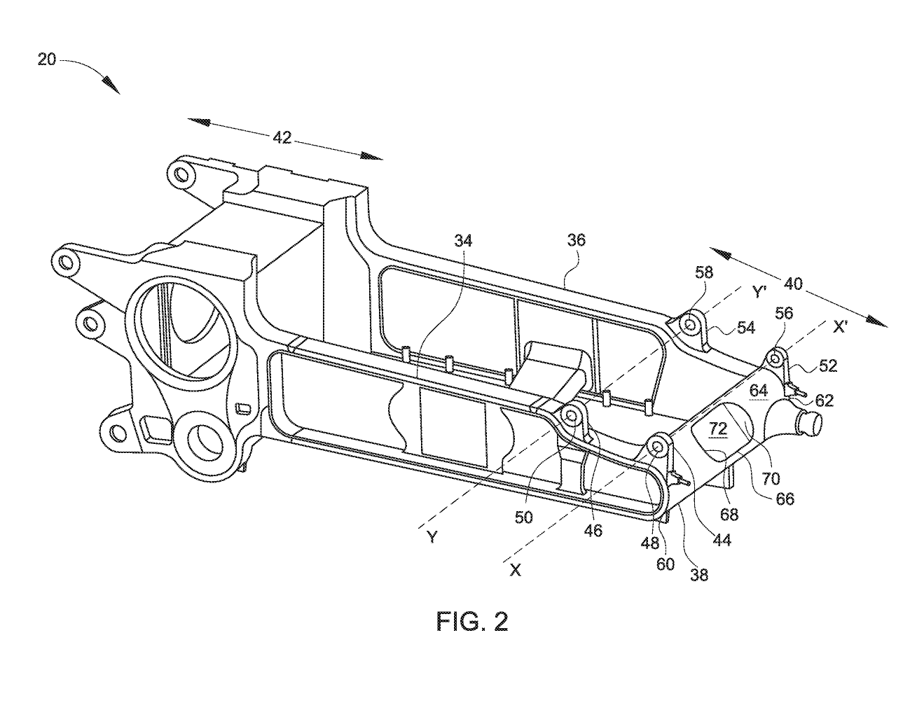

Referring to FIG. 2, there is shown the frame 20 of the machine 10. The frame 20 includes a first longitudinal member 34, a second longitudinal member 36, and a third member 38. Each of the first longitudinal member 34 and the second longitudinal member 36 extend along a length of the machine 10, to define a first end portion 40 and a second end portion 42 of the frame 20. The first end portion 40 of the frame 20 is proximal to the front end 24 of the machine 10. Similarly, the second end portion 42 is proximal to the rear end 28 of the machine 10.

The first longitudinal member 34 is an elongated member that includes a first pivot attachment portion 44 and a first fixed attachment portion 46. Each of the first pivot attachment portion 44 and the first fixed attachment portion 46 are located on the first end portion 40 of the frame 20. More specifically, each of the first pivot attachment portion 44 and the first fixed attachment portion 46 are positioned proximal to the front end 24 of the machine 10. The first fixed attachment portion 46 is positioned rearwardly away from the first pivot attachment portion 44, relative to the front end 24 of the machine 10. The first pivot attachment portion 44 includes a first pivot mounting hole 48. The first fixed attachment portion 46 includes a first fixed mounting hole 50.

The second longitudinal member 36 is an elongated member positioned parallel and spaced apart from the first longitudinal member 34. The second longitudinal member 36 includes a second pivot attachment portion 52 and a second fixed attachment portion 54. Each of the second pivot attachment portion 52 and the second fixed attachment portion 54 are located on the first end portion 40 of the frame 20. More specifically, each of the second pivot attachment portion 52 and the second fixed attachment portion 54 are positioned proximal to the front end 24 of the machine 10. The second fixed attachment portion 54 is positioned rearwardly away from the second pivot attachment portion 52, relative to the front end 24 of the machine 10. The second pivot attachment portion 52 includes a second pivot mounting hole 56. The second fixed attachment portion 54 includes a second fixed mounting hole 58.

The first pivot attachment portion 44 and second pivot attachment portion 52 are positioned, such that the first pivot mounting hole 48 is axially aligned to the second pivot mounting hole 56 along a first lateral axis X-X′. Additionally, the first fixed attachment portion 46 and the second pivot attachment portion 52 are positioned, such that the first fixed mounting hole 50 is axially aligned to the second fixed mounting hole 58 along a second lateral axis Y-Y′.

The third member 38 extends laterally between the first longitudinal member 34 and the second longitudinal member 36, proximal to the front end 24 of the machine 10. More specifically, the third member 38 includes a first extreme end 60 and a second extreme end 62. The first extreme end 60 of the third member 38 is attached to the first longitudinal member 34. Similarly, the second extreme end 62 of the third member 38 is attached to the second longitudinal member 36. The third member 38 is positioned, such that the first extreme end 60 is positioned adjacent to the first pivot attachment portion 44 and the second extreme end 62 is positioned adjacent to the second pivot attachment portion 52. The third member 38 includes a radiator guard facing surface 64 that defines an indented portion 66.

The indented portion 66 of the third member 38 is a C-shaped cavity that defines a first side 68, a second side 70, and a horizontal surface 72. The horizontal surface 72 is a flat surface defined between the first side 68 and the second side 70 of the indented portion 66. The first side 68 and the second side 70 extend outward from the horizontal surface 72 towards the radiator guard facing surface 64 of the third member 38. In the present embodiment, the indented portion 66 is a C-shaped cavity, however, the indented portion 66 may embody any shape and size for a given embodiment.

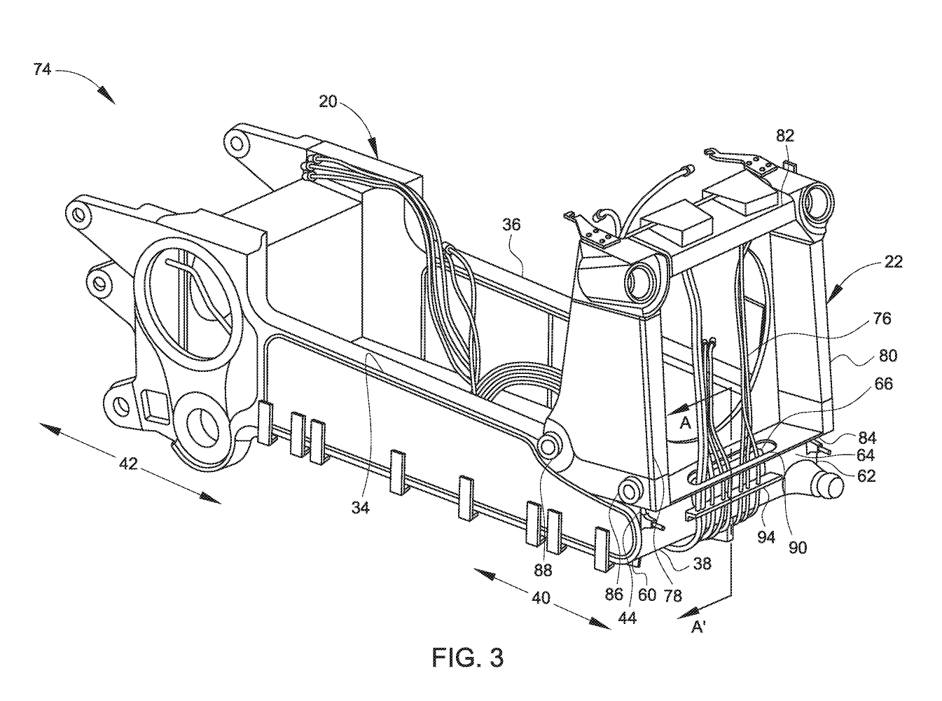

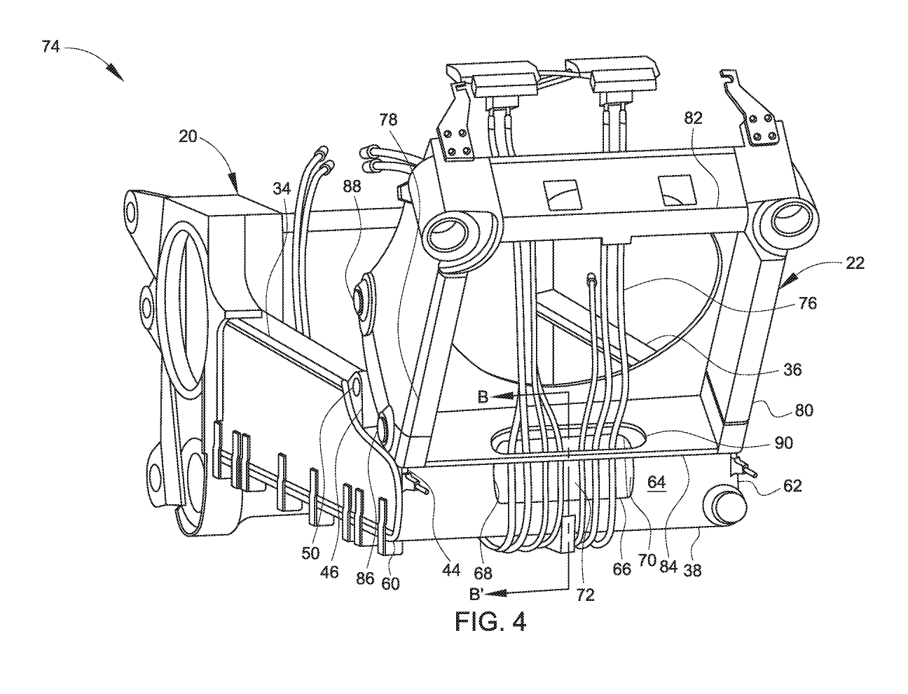

Referring to FIGS. 3 and 4, there is shown an assembly 74 of the frame 20 and the radiator guard 22, illustrating structure and arrangement of the radiator guard 22 relative to the frame 20. Additionally, a routing arrangement of a plurality of flexible members 76 through the assembly 74 is shown in FIGS. 3 and 4. The radiator guard 22 is a rectangular semi-closed structure that includes a first side cover 78, a second side cover 80, a top portion 82, and a bottom portion 84. Although, in the present disclosure, the radiator guard 22 is described as a rectangular semi-closed structure, however the radiator guard 22 may be contemplated to include any shape and size.

The first side cover 78 of the radiator guard 22 is a vertical member that includes a first pivot mounting point 86 and a first fixed mounting point 88. The second side cover 80 of the radiator guard 22 is a vertical member and is positioned parallel to the first side cover 78. The second side cover 80 includes a second pivot mounting point (not shown) and a second fixed mounting point (not shown). The top portion 82 of the radiator guard 22 extends between the first side cover 78 and the second side cover 80. Additionally, the bottom portion 84 of the radiator guard 22 extends between the first side cover 78 and the second side cover 80. A cavity 90 is defined on the bottom portion 84 of the radiator guard 22. The bottom portion 84 may embody any shape and structure in a given embodiment.

The radiator guard 22 is supported on the frame 20, proximal to the front end 24 of the machine 10. More specifically, the radiator guard 22 is installed on the first end portion 40 of the frame 20.

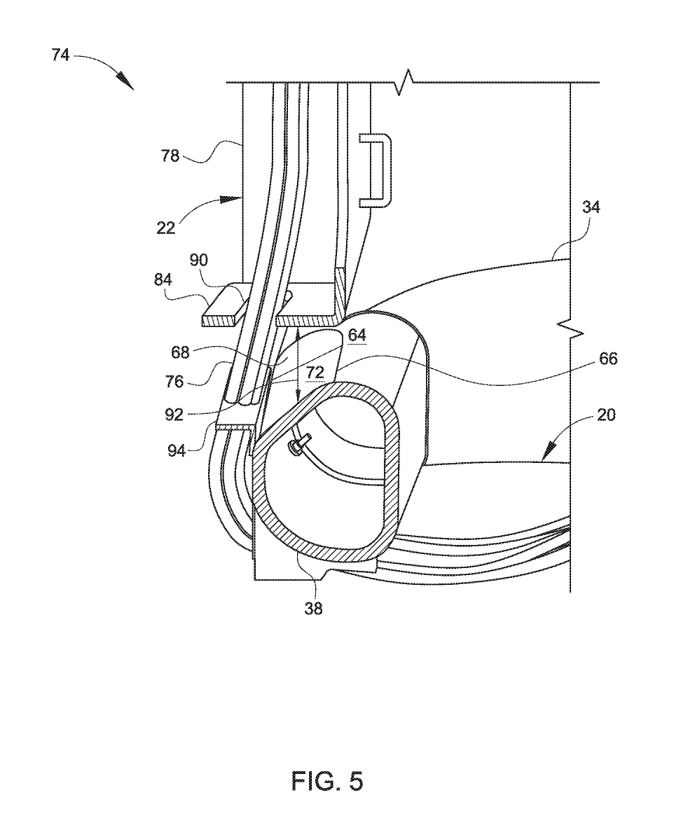

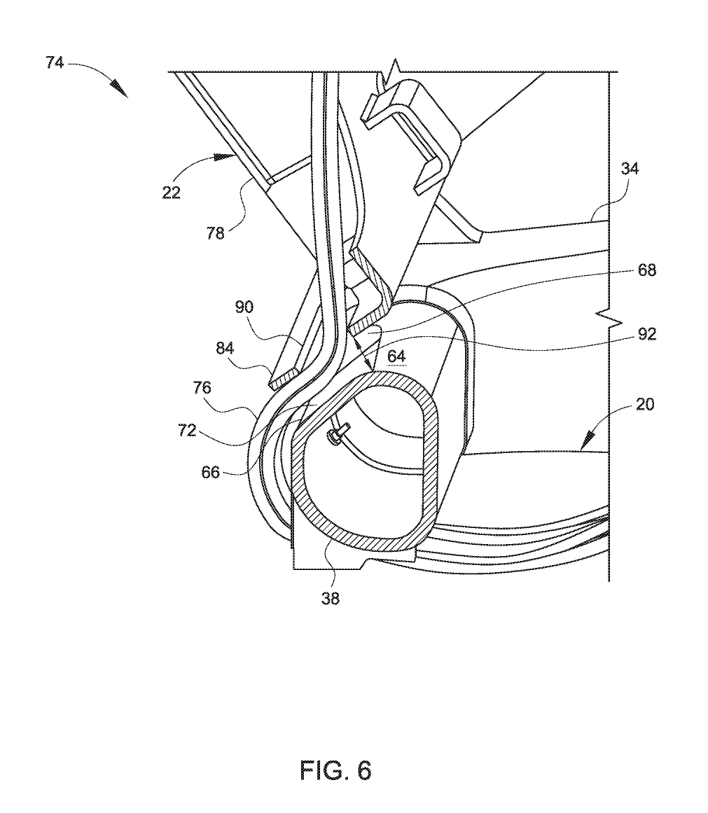

To install the radiator guard 22 on the frame 20, the first pivot mounting point 86 of the first side cover 78 is pivotally attached to the first pivot attachment portion 44 of the first longitudinal member 34. A first pivot pin (not shown) passes through each of the first pivot mounting point 86 and the first pivot attachment portion 44, to facilitate pivotal attachment between the first side cover 78 and the first longitudinal member 34. The second pivot mounting point (not shown) of the second side cover 80 is pivotally attached to the second pivot attachment portion 52 of the second longitudinal member 36. A second pivot pin (not shown) passes through each of second pivot mounting point (not shown) and the second pivot attachment portion 52, to facilitate pivotal attachment between the second side cover 80 and the second longitudinal member 36. Therefore, the radiator guard 22 is pivotally supported on the frame 20. With such installation, the third member 38 of the frame 20 is positioned beneath the bottom portion 84 of the radiator guard 22. Additionally, with such installation, a gap 92 (refer to FIG. 5 and FIG. 6) is defined between the bottom portion 84 of the radiator guard 22 and the third member 38 of the frame 20.

Furthermore, during an assembled event of the radiator (not shown), as is shown in FIG. 3, the radiator guard 22 is positioned in an upright position relative to the frame 20. The radiator guard 22 is maintained in the upright position, by attaching the first fixed mounting point 88 to the first fixed attachment portion 46 and attaching the second fixed mounting point (not shown) to the second fixed attachment portion 54. A number of fastening pins (not shown) may be employed to attach the first fixed mounting point 88 to the first fixed attachment portion 46 and the second fixed mounting point (not shown) to the second fixed attachment portion 54.

During a maintenance event of the radiator (not shown), as is shown in FIG. 4, the radiator guard 22 is pivotally adjusted to an inclined position relative to the frame 20. In the inclined position, the first fixed mounting point 88 is detached from the first fixed attachment portion 46 and the second fixed mounting point (not shown) is detached from the second fixed attachment portion 54. Therefore, the radiator guard 22 is adjusted in the inclined position, by pivoting the radiator guard 22, about the first pivot attachment portion 44 and the second pivot attachment portion 52.

Furthermore, the flexible members 76, such as hosepipes and electrical pipes, are routed through the frame 20, such that the flexible members 76 extend from first end portion 40 of the frame 20 to the second end portion 42 of the frame 20. At the first end portion 40, the flexible members 76 are routed through the cavity 90 of the bottom portion 84. The flexible members 76 further pass through the gap 92 between the bottom portion 84 and the third member 38. Moreover, the flexible members 76 extend toward the second end portion 42 of the frame 20, by routing below the third member 38. However, the flexible members 76 may be routed in any form and manner for a given embodiment. The flexible members 76 may embody any member routed between the first end portion 40 and the second end portion 42 of the frame 20, for machine operability.

Referring to FIG. 5, a side view of a cut section of the assembly 74 of the radiator guard 22 and the frame 20 of FIG. 2, taken along a section A-A′ is shown. As is shown in FIG, 5, the radiator guard 22 is positioned in the upright position. In the upright position of the radiator guard 22, a support bracket 94 holds the flexible members 76 with the third member 38. Position of the support bracket 94 provides routing stability to the flexible members 76. Further, in the upright position, the flexible members 76 are routed through the gap 92 between the bottom portion 84 and the third member 38.

Referring to FIG. 6, a side view of a cut section of the assembly 74 of the radiator guard 22 and the frame 20 of FIG. 3, taken along a section B-B′ is shown. As is shown in FIG. 6, the radiator guard 22 is positioned in the inclined position. In the inclined position of the radiator guard 22, the support bracket 94 is removed to provide a movement flexibility to the flexible members 76. Further, in the inclined position, the flexible members 76 are accommodated within the indented portion 66 of the third member 38.

### INDUSTRIAL APPLICABILITY

In operation, as is shown in FIG. 5, the radiator guard 22 is supported on the first end portion 40 of the frame 20. During the assembled event of the radiator (not shown), the radiator guard 22 is positioned in the upright position. In the upright position of the radiator guard 22, as shown in FIG, 5, the flexible members 76 pass through the cavity 90 of the bottom portion 84 of the radiator guard 22. The flexible members 76 are further routed through the gap 92 between the bottom portion 84 and the third member 38.

Furthermore, as is shown in FIG. 6, during the maintenance event for the radiator (not shown), the radiator guard 22 is pivotally adjusted about the first pivot attachment portion 44 and the second pivot attachment portion 52, to be adjusted to the inclined position. In order to adjust the radiator guard 22 to the inclined position, the first fixed mounting point 88 and the second fixed mounting point (not shown) are detached from the first fixed attachment portion 46 and the second fixed attachment portion 54, respectively. Additionally, the support bracket 94 is uninstalled from the third member 38, to provide a freedom of movement to the flexible members 76. In the inclined position, the gap 92 between the bottom portion 84 and the third member 38 reduces. With the reducing gap 92, the bottom portion 84 of the radiator guard 22 pushes the flexible members 76 towards the third member 38. More specifically, the flexible members 76 move towards the indented portion 66, such that the flexible members 76 are supported on the horizontal surface 72 of the indented portion 66.

The third member 38 of the disclosed frame 20 includes the indented portion 66, which accommodates the flexible members 76 in the inclined position the radiator guard 22. The indented portion 66 on the radiator guard facing surface 64 provides an adjustment space to the flexible members 76 for a movement between the bottom portion 84 and the third member 38. This prevents damage of the flexible members 76 during repeated pivotal movements of the radiator guard 22.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of the disclosure. Such embodiments should be understood to fall within the scope of the present disclosure as determined based upon the claims and any equivalents thereof.

What is claimed is:

1. A frame for supporting a radiator guard of a machine, the radiator guard having a bottom portion, the frame comprising:
a first longitudinal member extending along a length of the machine, the first longitudinal member including a first pivot attachment portion proximal to a front end of the machine;
a second longitudinal member extending along the length of the machine and positioned parallel to the first longitudinal member, the second longitudinal member including a second pivot attachment portion proximal to the front end of the machine, the second pivot attachment portion and the first pivot attachment portion being adapted to pivotally support the radiator guard; and
a third member laterally extending between the first longitudinal member and the second longitudinal member, the third member being positioned beneath the bottom portion of the radiator guard, such that a gap is defined between the bottom portion and the third member, the third member including an indented portion proximal to the bottom portion of the radiator guard;
wherein a plurality of flexible members is routed through the gap during an upright position of the radiator guard and is accommodated within the indented portion of the third member during an inclined position of the radiator guard.
